(19) United States
(12) Patent Application Publication
(10) Pub. No.: US 2018/0129975 A1
(43) Pub. Date: May 10, 2018

(54) APPARATUS AND METHOD OF ADJUSTING A SENSITIVITY BUFFER OF SEMI-SUPERVISED MACHINE LEARNING PRINCIPALS FOR REMEDIATION OF ISSUES IN A COMPUTER ENVIRONMENT

(71) Applicant: SIOS Technology Corporation, Lexington, SC (US)

(72) Inventors: Sergey A. Razin, Columbia, SC (US); Yokuki To, Columbia, SC (US); Tracy L. Marlatt, Lexington, SC (US)

(73) Assignee: SIOS Technology Corporation, Lexington, SC (US)

(21) Appl. No.: 15/800,809

(22) Filed: Nov. 1, 2017

Related U.S. Application Data
(60) Provisional application No. 62/415,889, filed on Nov. 1, 2016.

(51) Int. Cl. G06N 99/00; G06N 5/02

(52) U.S. Cl. CPC G06N 99/005; G06N 5/02

(57) ABSTRACT

In a host device, a method for performing an anomaly analysis of a computer environment includes applying a learned behavior function to a data training set and to a set of data elements received from at least one computer environment resource to define at least one learned behavior boundary relative to at least one cluster of data elements of the data training set; applying a sensitivity function to the at least one cluster to define a sensitivity boundary relative to at least one learned behavior boundary, the sensitivity boundary related to a variance associated with the at least one cluster and to a mean value of the at least one cluster; and identifying a data element of the set of data elements as an anomalous data element when the data element of the set of data falls outside of the sensitivity boundary.

### RELATED APPLICATIONS

This patent application claims the benefit of U.S. Provisional Application No. 62/415,889, filed on Nov. 1, 2016, entitled, “Apparatus and Method of Adjusting a Sensitivity Buffer of Semi-Supervised Machine Learning Principals for Remediation of Issues in a Computer Environment,” the contents and teachings of which are hereby incorporated by reference in their entirety.

### BACKGROUND

Modern economies and business services typically run complex, dynamic, and heterogeneous Information Technology (IT) computer infrastructures. For example, computer infrastructures can include one or more server or host devices and one or more storage arrays interconnected by communication devices, such as switches or routers. The server devices can be configured to execute one or more virtual machines (VMs) during operation. Each VM can execute or run one or more applications or workloads. Such workloads can be executed as part of on-premise (datacenter) and off-premise (public/private cloud) environments.

During operation, performance issues can affect the applications executed in the cloud/virtualization environments. These performance issues can be related to storage, specifically datastore contention. A datastore is defined as an object that is shared with VMs on the same host and/or on different hosts within an environment. Datastore contention can be caused by many different events, changes, and/or issues within the environment and can be identified by an abnormal increase in input/output (IO) latency associated with the environment. While IO latency can typically affect all of the applications on a given datastore, for storage contention, the IO latency is originated at the datastore.

For example, with reference to FIG. 1, during operation of a computer infrastructure 2, a virtual machine 3 of a server device 4 can perform a backup of other virtual machines from another server device. In this case, assume virtual machine 3-14 of server device 4-2 is configured to backup virtual machine 3-4, virtual machine 3-5, and virtual machine 3-6 of server device 4-2. Further assume that, at a later point, a systems administrator migrates virtual machine 3-14 to server device 4-4. It is noted that even after the migration, the virtual machine 3-14 remains configured to perform a backup of virtual machines 3-4, 3-5, and 3-6. These backups can create pressure (e.g., IOPS) that would result in latency on various aspects of the computer infrastructure 2. Because virtual machines 3-1, 3-2, and 3-3 are related to virtual machines 3-4, 3-5, and 3-6 through the network 5, a back-up of virtual machines 3-4, 3-5, and 3-6 can affect the performance, and cause latency of, the virtual machines 3-1, 3-2, and 3-3 of datastore 7.

In certain computer infrastructures, a host device can be configured to identify anomalies in the behavior of components of the computer infrastructure which can potentially cause performance issues, such as datastore contention. In one arrangement, the host device can utilize machine learning techniques, such as semi-supervised machine learning techniques, to identify behavior anomalies associated with the computer infrastructure. For example, with reference to FIG. 1, a host device 6 can be configured to utilize semi-supervised machine learning techniques to detect latency in the computer infrastructure 2, such as originated at the datastore 7.

### SUMMARY

As provided above, using semi-supervised machine learning techniques, a host device can learn of acceptable behavior values for the various components of the computer infrastructure over time. Further, during an anomaly identification process, the host device can identify anomalous behavior of components of the computer infrastructure as behavior which falls outside of the set of acceptable behavior values. In certain cases, in order to limit or prevent the reporting of insignificant anomalies (e.g., certain identified anomalous behavior which falls outside of the set of behavior values), the host device can be configured to apply a calculated buffer to the set of behavior values during an anomaly detection process. The calculated buffer effectively adjusts the boundaries associated with the set of learned behavioral values. For example, in the case where the host device detects a behavior value as falling outside of the set of acceptable behavior values but within an extended buffer range boundary, the host device can identify the detected behavioral value as being a non-anomalous value.

While the host device can be configured to distinguish meaningful (e.g., actual or outlier) anomalies from relatively insignificant anomalies using a static, calculated buffer, the application of conventional buffers do not allow for user input to adjust the buffer. As such, the end user, such as a systems administrator, cannot adjust the buffer value to account for variations within particular computer infrastructures. Further, a preconfigured buffer value may not be applicable to all types of behavior data identified by the host device. For example, latency data associated with a computer environment is substantially static, with minimal variance over time, while CPU utilization data can be dynamic, with relatively larger variance over time.

By contrast to conventional anomalous behavior detection, embodiments of the present innovation relate to an apparatus and method of adjusting a sensitivity buffer of semi-supervised machine learning principals for remediation of issues in a computer environment. In one arrangement, the host device is configured with a semi-supervised machine learning function which relates a mean value of a given cluster to a learned behavior boundary associated with groupings of clusters. This allows the host device to improve the practical meaning of anomalies derived from machine learning models and to limit reporting of relatively insignificant anomalies. Further, the host device is configured to incorporate user input into the anomaly detection process. For example, the user can adjust a sensitivity value associated with the semi-supervised machine learning technique to allow the end user to influence the semantics of the sensitivity adjustment and to account for particular variations within a given computer infrastructure.

In one arrangement, embodiments of the innovation relate to, in a host device, a method for performing an anomaly analysis of a computer environment. The method includes applying, by host device, a learned behavior function to a data training set and to a set of data elements received from at least one computer environment resource to define at least one learned behavior boundary relative to at least one cluster of data elements of the data training set, the at least one learned behavior boundary related to a variance associated with the at least one cluster. The method includes applying, by host device, a sensitivity function to the at least one cluster to define a sensitivity boundary relative to at least one learned behavior boundary, the sensitivity boundary related to the variance associated with the at least one cluster and to a mean value of the at least one cluster. The method includes identifying, by host device, a data element of the set of data elements as an anomalous data element associated with an attribute of the at least one computer environment resource when the data element of the set of data falls outside of the sensitivity boundary.

In one arrangement, embodiments of the innovation relate to a host device having a controller comprising a memory and a processor. The controller is configured to apply a learned behavior function to a data training set and to a set of data elements received from at least one computer environment resource to define at least one learned behavior boundary relative to at least one cluster of data elements of the data training set, the at least one learned behavior boundary related to a variance associated with the at least one cluster; apply a sensitivity function to the at least one cluster to define a sensitivity boundary relative to at least one learned behavior boundary, the sensitivity boundary related to the variance associated with the at least one cluster and to a mean value of the at least one cluster; and identify a data element of the set of data elements as an anomalous data element associated with an attribute of the at least one computer environment resource when the data element of the set of data falls outside of the sensitivity boundary.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a prior art computer infrastructure.

FIG. 2 illustrates a schematic depiction of a computer system, according to one arrangement.

FIG. 3 illustrates a schematic depiction of the host device of FIG. 2 executing an analytics platform, according to one arrangement.

FIG. 4 illustrates a graph showing the application of a clustering function to a data training set of FIG. 3, according to one arrangement.

FIG. 5 illustrates a graph showing the application of a learned behavior function to the data training set of FIG. 3, according to one arrangement.

FIG. 6 illustrates a graph showing the application of a sensitivity function to the data training set of FIG. 3, according to one arrangement.

FIG. 7 is a graph that illustrates, in part, how the mean value of a cluster influences an adjusted buffer value, according to one arrangement.

FIG. 8A is a first view of a graph that illustrates the relationships among sensitivity adjustment values, the mean values of a cluster, and the standard deviation values of the cluster, according to one arrangement.

FIG. 8B is a second view of the graph of FIG. 8A that illustrates the relationships among sensitivity adjustment values, the mean values of a cluster, and the standard deviation values of the cluster, according to one arrangement.

FIG. 8C is a third view of the graph of FIG. 8A that illustrates the relationships among sensitivity adjustment values, the mean values of a cluster, and the standard deviation values of the cluster, according to one arrangement.

FIG. 9A is a first view of a graph that illustrates the relationships among sensitivity adjustment values, the mean values of a cluster, and the standard deviation values of the cluster, according to one arrangement.

FIG. 9B is a second view of the graph of FIG. 9A that illustrates the relationships among sensitivity adjustment values, the mean values of a cluster, and the standard deviation values of the cluster, according to one arrangement.

FIG. 9C is a third view of a graph of FIG. 9A that illustrates a third view of the relationships among sensitivity adjustment values, the mean values of a cluster, and the standard deviation values of the cluster, according to one arrangement.

FIG. 10 illustrates schematic depiction of a graphical user interface provided by the host device of FIG. 2 to the display, according to one arrangement.

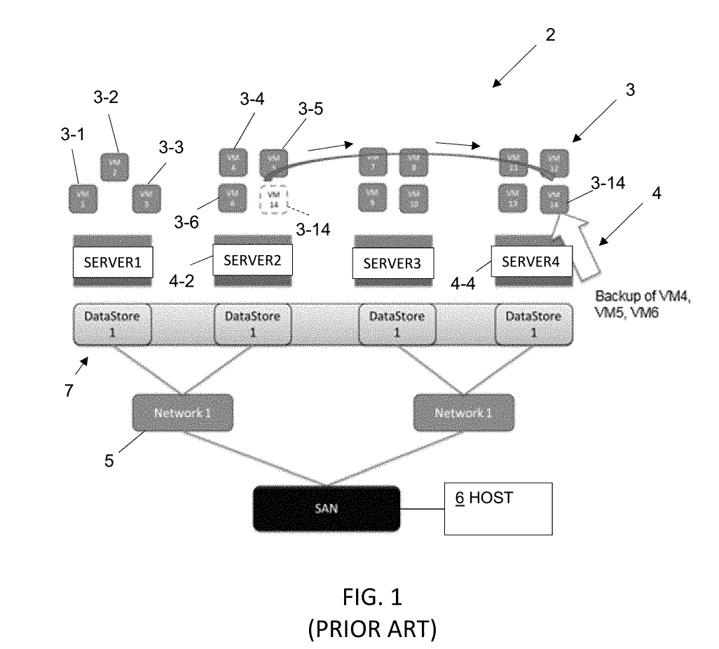

### DETAILED DESCRIPTION

Embodiments of the present innovation relate to an apparatus and method of adjusting a sensitivity buffer of semi-supervised machine learning principals for remediation of issues in a computer environment. In one arrangement, the host device is configured with a semi-supervised machine learning function which relates a mean value of a given cluster to a learned behavior boundary associated with groupings of clusters. This allows the host device to improve the practical meaning of anomalies derived from machine learning models and to limit reporting of relatively insignificant anomalies. Further, the host device is configured to incorporate user input into the anomaly detection process. For example, the user can adjust a sensitivity value associated with the semi-supervised machine learning technique to allow the end user to influence the semantics of the sensitivity adjustment and to account for particular variations within a given computer infrastructure.

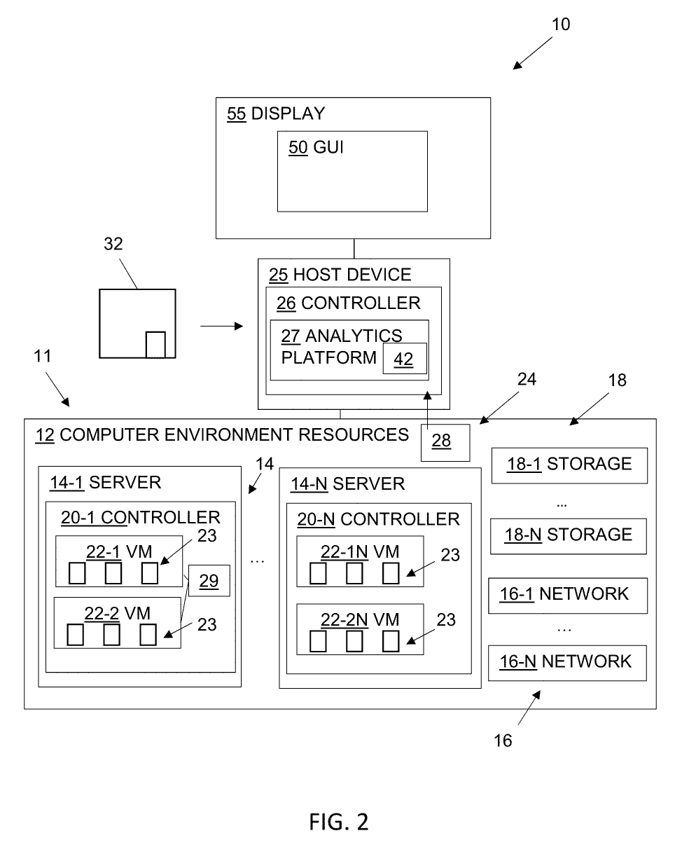

FIG. 2 illustrates an arrangement of a computer system 10 which includes at least one computer infrastructure 11 disposed in electrical communication with a host device 25. While the computer infrastructure 11 can be configured in a variety of ways, in one arrangement, the computer infrastructure 11 includes computer environment resources 12. For example, the computer environment resources 12 can include one or more server devices 14, such as computerized devices, one or more network communication devices 16, such as switches or routers, and one or more storage devices 18, such as disk drives or flash drives.

Each server device 14 can include a controller or compute hardware 20, such as a memory and processor. For example, server device 14-1 includes controller 20-1 while server device 14-N includes controller 20-N. Each controller 20 can be configured to execute one or more virtual machines 22 with each virtual machine (VM) 22 being further configured to execute or run one or more applications or workloads 23. For example, controller 20-1 can execute a first virtual machine 22-1 and a second virtual machine 22-2, each of which, in turn, is configured to execute one or more workloads 23. Each compute hardware element 20, storage device element 18, network communication device element 16, and application 23 relates to an attribute of the computer infrastructure 11.

In one arrangement, the VMs 22 of the server devices 14 can include one or more shared objects or datastores 29. For example, server device 14-1 includes a first VM 22-1 and a second VM 22-2 which share a datastore 29.

In one arrangement, the host device 25 is configured as a computerized device having a controller 26, such as a memory and a processor. The host device 25 is disposed in electrical communication with one or more computer infrastructures 11, such as via a network connection, and with a display 55.

The host device 25 is configured to receive, via a communications port (not shown) a set of data elements 24 from at least one computer environment resource 12 of the computer infrastructure 11 where each data element 28 of the set of data elements 24 relates to an attribute of the computer environment resources 12. For example, the data elements 28 can relate to the compute level (compute attributes), the network level (network attributes), the storage level (storage attributes), and/or the application or workload level (application attributes) of the computer environment resources 12.

During operation, the host device 25 is configured to poll the computer environment resources 12, such as via private API calls, to obtain data elements 28 relating to the compute, storage, and network attributes of the computer infrastructure 11. For example, the host device 25 can receive data elements 28 that relate to the controller configuration and utilization of the servers devices 12 (i.e., compute attribute), the VM activity in each of the server devices 14 (i.e., application attribute) and the current state and historical data associated with the computer infrastructure 11. In one arrangement, each data element 28 can include additional information relating to the computer infrastructure 11, such as events, statistics, and the configuration of the computer infrastructure 11. For example, the data elements 28 can include information relating to storage I/O related statistics from each server device 14, as well as statistics for the VMs 22 that are associated with a given datastore 29.

While the host device 25 can receive the data elements 28 from the computer infrastructure 11 in a variety of ways, in one arrangement, the host device 25 is configured to receive the data elements 28 from the computer infrastructure 11 as part of a substantially real-time stream. By receiving the data elements 28 as a substantially real-time stream, the host device 25 can monitor activity of the computer infrastructure 11 on a substantially ongoing basis. This allows the host device 25 to detect anomalous activity associated with one or more computer environment resources 12 over time.

In one arrangement, the host device 25 includes an analytics platform 27 configured to execute an anomalous behavior analysis function 42 on the data elements 28 received from the computer infrastructure 11. While the host device 25 can be configured to perform a variety of types of anomalous behavior analyses, in one arrangement, the host device 25 is configured to perform a datastore contention analysis on the data elements 28.

With continued reference to FIG. 2, the controller 26 of the host device 25 can store an application for the analytics platform 27. For example, the analytics platform application installs on the controller 26 from a computer program product 32. In some arrangements, the computer program product 32 is available in a standard off-the-shelf form such as a shrink wrap package (e.g., CD-ROMs, diskettes, tapes, etc.). In other arrangements, the computer program product 32 is available in a different form, such downloadable online media. When performed on the controller 26 of the host device 25, the analytics platform application causes the host device 25 to perform the anomalous behavior analysis.

The host device 25 can be configured to determine the presence of a variety of types of anomalous behaviors associated with the computer infrastructure 11. In one arrangement, and as provided by way of example only, the host device 25 is configured to perform the anomalous behavior analysis in order to identify datastore resource contentions associated with the computer infrastructure 11. As indicated above, problems with storage I/O are conventionally caused by datastore contention. Typically, the symptom of such events is an increase in latency in the host device-datastore pairing. As the datastore contention develops, commands begin to be aborted by the host device 25, normally for a single request at first, and perhaps eventually for all requests in the queue if the situation is not addressed.

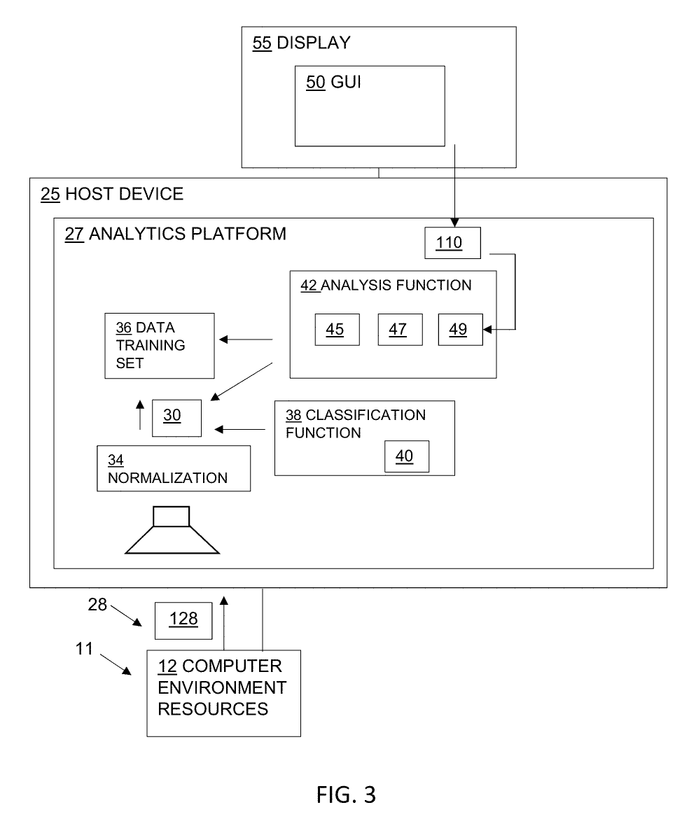

With reference to FIG. 3, and with respect to the detection of datastore contention, the host device 25 is configured to collect, as the data elements 28, latency information or latency data elements 128 (e.g., input/output (IO) latency, input/output operations per second (IOPS) latency, etc.) regarding the computer environment resources 12 of the computer infrastructure 11. For example, the host device 25 is configured to poll the computer environment resources 12, such as via private API calls, to obtain data elements 128 relating to latency within the computer infrastructure 11. The data elements 128 can include latency statistics of a distributed datastore object and performance statistics of each individual VM that is associated with the datastore 29.

In one arrangement, as the host device 25 receives the data elements 28, the host device 25 is configured to direct the data elements 28 to a uniformity or normalization function 34 to normalize the data elements 28. Application of the uniformity function to the data elements 28 generates normalized data elements 30. For example, any number of the computer environment resources 12 can provide the data elements 28 to the host device 25 in a proprietary format. In such a case, the normalization function 34 of the host device 25 is configured to convert or normalize the data elements 28 to a standard, non-proprietary format. In another example, as the host device 25 receives the data elements 28 over time, the data elements 28 can be presented with a variety of time scales. For example, for data elements 28 received from multiple network devices 16 of the computer infrastructure 11, the latency of the devices 16 can be presented in seconds (s) or milliseconds (ms). In such an example, the normalization function 34 of the host device 25 is configured to format the data elements 28 to a common time scale.

Normalization of the data elements 28 for application of a classification function 38, such as a clustering function 40 as described below, provides equal scale for all data elements 28 and a balanced impact on the distance metric utilized by the classification function (e.g., Euclidean distance metric). Moreover, in practice, normalization of the data elements 28 tends to produce clusters that appear to be roughly spherical, a generally desirable trait for cluster-based analysis.

Next, the host device 25 is configured to develop a data training set 36 for use in anomalous behavior detection. The data training set 36 is configured as a baseline set of data used by the host device 25 to identify particular patterns or trends of behavior of the computer environment resources 12.

In one arrangement, the host device 25 is configured to apply a classification function 38 to the normalized latency data elements 30 (i.e., to the attribute of the computer infrastructure resources of the computer infrastructure) to develop the data training set 36. While the classification function 38 can be configured in a variety of ways, in one arrangement, the classification function 38 is configured as a semi-supervised machine learning function, such as a clustering function 40.

Clustering is the task of grouping a set of objects in such a way that objects in the same group, called a cluster, are more similar to each other than to the objects in other groups or clusters. Clustering is a conventional technique for statistical data analysis, used in many fields, including machine learning, pattern recognition, image analysis, information retrieval, and bioinformatics. The grouping of objects into clusters can be achieved by various algorithms that differ significantly in their notion of what constitutes a cluster and how to efficiently find them. For example, known clustering algorithms include hierarchical clustering, centroid-based clustering (i.e., K-Means Clustering), distribution based clustering, and density based clustering. Based upon application of the clustering function 40, the host device 25 is configured to detect anomalies or degradation in performance as associated with the various components or attributes of the computer infrastructure 11.

In one arrangement, with application of the classification function 38, the host device 25 is configured to access the normalized latency data elements 30 to develop the data training set 36. The host device 25 can develop the data training set 36 in a substantially continuous and ongoing manner by receiving normalized latency data elements 30, where the data elements originate from the computer environment resources 12, over time. For example, with reference to FIG. 3 to develop the data training set 36, the host device 25 receives a substantially real time stream of data elements 28, such as latency data elements 128, from a the computer infrastructure 11, which are then normalized (e.g., normalized data elements 30), over a period of time. In one arrangement, the host device 25 is configured to apply a training function (not shown) to the normalized data elements 30 to continuously develop and train the data training set 36 based upon the ongoing stream of data elements 28. Accordingly, as the computer infrastructure attribute values change over time (e.g., shows an increase or decrease in CPU utilization for particular controllers of the computer infrastructure 11) the data training set 36 can change over time, as well.

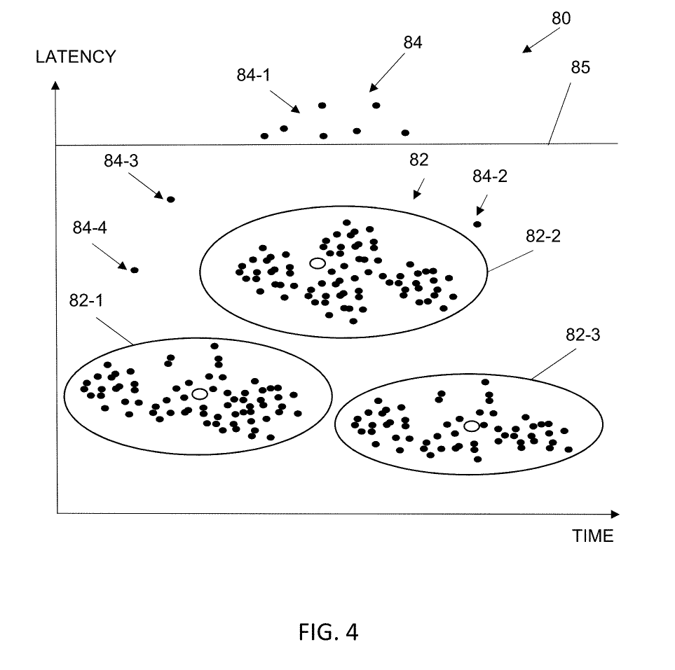

In one arrangement, with application of the clustering function 40 to the normalized data elements 30, the host device 25 stores the data training set 36 as clusters. For example, the data training set 36 is a model encapsulated in clusters which defines values such as mean, standard deviation, maximum value, minimum value, size (e.g., the number of data points in the cluster), and a density function (e.g., how densely populated is a cluster) per object. The maximum value and minimum value can apply to the x-axis (e.g., time) and y-axis (e.g., an attribute such as latency), such as indicated in FIG. 4. Based upon the clustering, the host device 25 can identify certain characteristics of the attribute, as well as the duration of the latency, based on the height and width of the cluster.

FIG. 4 illustrates a graph 80 showing an example of the application of the classification function 38 to the data elements 30 to generate the data training set 36. In one arrangement, application of the classification function 38 (e.g., clustering function 40) to the normalized data elements 30 can result in the generation of sets of clusters 82. For example, following application of the classification function 38 to the normalized data elements 30, the resulting training data set 36 can include first, second, and third clusters 82-1, 82-2, and 82-3, where each cluster 82-1 through 82-3 identifies computer infrastructure attributes having some common similarity (e.g., input/output (IO) latency, input/output operations per second (IOPS) latency, etc.).

In one arrangement, with reference to FIG. 3, after developing the data training set 36, the host device 25 is configured to apply an analysis function 42 to the data training set 36 and to the normalized data elements 30 received by the host device 25 to identify anomalies associated with the computer infrastructure 11.

For example, the host device 25 is configured to utilize the analysis function 42 as applied to particular sets of use cases of the data training set 36, such as datastore contention and storage performance latencies, to detect anomalies related to latency as associated with various computer environment resources 12 of the computer infrastructure 11. With reference to FIG. 3, the host device 25 can apply the analysis function 42 to the data training set 36 and to the normalized latency data elements 30 to determine anomalies of the latency information associated with the computer infrastructure 11.

As provided above, and with continued reference to FIG. 3, when applying the analysis function 42 to the data training set 36 and to the normalized data elements 30, the host device 25 is configured to compare the normalized latency data elements 30 with the data training set 36. With such application of the analysis function 42, the host device 25 can determine trends associated with the normalized data elements 30, as well as the presence of anomalous behavior associated with the computer environment resources 11.

For example, with application of the analysis function 42, the host device 25 compares normalized latency data elements 30 with the data training set 36. As a result, the host device 25 can identify outlying data elements 84 (e.g., data elements that fall outside of the clusters 82) as data anomalies which represent anomalous activity associated with the computer infrastructure 11. For example, with reference to FIG. 4, comparison of normalized latency data elements 30 with the data training set 36 can yield a number of objects or elements 84 which fall outside of the clusters 82. As a result of the analysis (e.g., application of the analysis function 42), the host device 25 can identify the data elements 84-1, 84-2, 84-3, and 84-4 falling outside of the clusters 82-1 through 82-3 of data elements and, as such, being indicative of anomalous data elements and anomalous behavior (e.g., latency) associated with the computer infrastructure 11.

In one arrangement, the analysis function 42 can be configured in a variety of ways to filter the anomalous data results determined by the host device 25.

For example, with reference to FIG. 3, the analysis function 42 can include a best practices function 45 and can apply a best practices boundary 85, as shown in FIG. 4, to the data elements 84-1, 84-2, 84-3, and 84-4 falling outside of the clusters 82-1 through 82-3. The best practices boundary 85 is configured as a cutoff to distinguish non-anomalous, non-clustered latency information elements (e.g., outlier elements) 84-1 from anomalous, non-clustered latency information elements. In the example shown in FIG. 4, application of the best practices function 45 generates a boundary 85 that excludes data elements 84-1 as being considered as anomalous data elements and identifies data elements 84-2, 84-3, and 84-4 as the anomalous data elements.

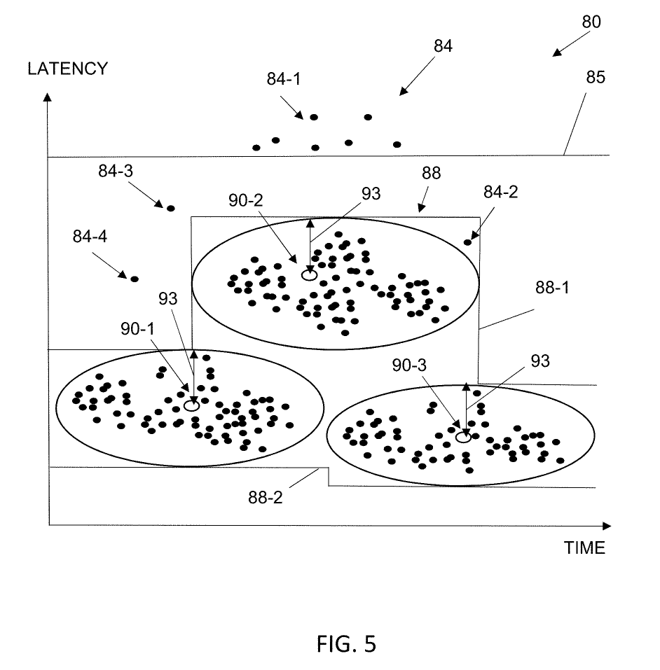

In another example, with reference to FIG. 3, the analysis function 42 can also include a learned behavior function 47. As indicated in FIG. 5, the host device 25 applies the learned behavior function 47 to the data training set 36 and to the normalized data elements 30 to define a learned behavior boundary 88 relative to the data element groupings of clusters 82. The learned behavior boundary 88 is related to the variance associated with the clusters 82 and is configured to provide a scalable threshold or cutoff to the clusters 82 to distinguish non-anomalous, non-clustered latency information elements from anomalous, non-clustered latency information elements. For example, the learned behavior function 47 defines the learned behavior boundary 88 as being three standard deviations 93 from the centroid 90 of each cluster 82.

In the example illustrated, when applying the learned behavior function 47, the host device 25 generates first (e.g., upper) and second (e.g., lower) learned behavior boundaries 88-1, 88-2 relative to the clusters 82. Based upon application of the learned behavior boundaries 88-1, 88-2, the learned behavior function 47 excludes data element 84-2 as being considered as anomalous data element, as that data element 84-2 falls within the learned behavior boundaries 88-1, 88-2. Further, application of the learned behavior function 47 identifies data elements 84-3 and 84-4 as the anomalous data elements as the data elements 84-3 and 84-4 that fall outside of the learned behavior boundaries 88-1, 88-2.

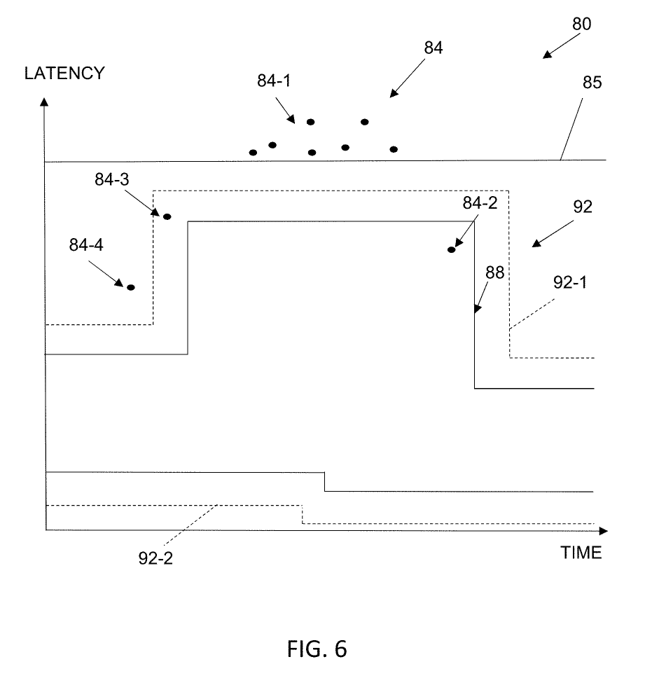

In another example, with reference to FIG. 3, the analysis function 42 can also include a sensitivity function 49. For example, with reference to FIG. 6, when applying the sensitivity function 49 to the clusters 82, the host device 25 defines a sensitivity boundary 92 relative to the previously-defined learned behavior boundaries 88. The sensitivity boundary 92 is configured to limit or prevent the reporting of insignificant anomalies and to provide the systems administrator with the ability to influence the semantics of the decision to include or exclude non-clustered data elements relative to the sensitivity boundary 92.

With continued reference to FIG. 6, the sensitivity boundary 92 is configured to define a buffer relative to the learned behavior boundaries 88 based upon metadata associated with each cluster 82 to further distinguish non-anomalous, non-clustered elements from anomalous, non-clustered elements. In the example illustrated, when applying the sensitivity function 49, the host device 25 applies first and second sensitivity boundaries 92-1, 92-2 to the learned behavior boundaries 88. Based upon application of the sensitivity function 49, the sensitivity boundaries 92-1, 92-2 exclude data element 84-3 as being considered an anomalous data element as the data element 84-3 falls within the learned behavior boundaries 88-1, 88-2. Further, application of the sensitivity function 49 provides data elements 84-4 as the anomalous data element as the data element 84-4 falls outside of the sensitivity boundaries 92-1, 92-2.

As provided below, different types of data elements 28 can have different types of inherent variances. The sensitivity function 49 can be configured to generate sensitivity boundaries 92 that accommodate different amounts of variance in the data elements 28 received from the computer infrastructure 11.

For example, data elements 28 related to the latency of the computer infrastructure 11, such as data elements 128, typically have relatively static values and a relatively low amount of variance. As a result, the average latency value associated with the latency data elements can remain relatively static over time. However, data elements 28 related to processor or CPU utilization within the computer infrastructure 11 can typically have relatively high amounts of variance. As a result, the average CPU utilization value associated with the CPU utilization data elements can change over time. Therefore, depending upon the attribute associated with the data elements 28, different types of data elements 28 can exhibit different types of behavior and can include different amounts of variance. The sensitivity function 49 is configured to take these different variances into account when generating the sensitivity boundaries 92.

In one arrangement, in order to take into account different amounts of variance in the data elements 28, the sensitivity function 49 is configured to generate a sensitivity boundary 92 related to a variance associated with a cluster 82 and to a mean value of the cluster 82, as associated with a particular type of data element 28.

For example, the sensitivity function 49 can be configured to relate the mean value of a given cluster 82 with a learned behavior boundary value 88, as provided by the following relation:

$${τ}^{*} = τ \pm δ ( γ μ \frac{μ}{τ} + {β}^{( 1 - μ / α )} ) ,$$

where the variables are provided as follows:
τ*—sensitivity boundary, or adjusted buffer, value
τ—the original learned behavior boundary value 88 or variance of the clusters 82. As provided above, τ=μ+3σ, (i.e., the learned behavior boundary 88 is three standard deviations from the centroid or mean 90 of each cluster 82). Accordingly, both the mean, μ, and variance can impact the computed sensitivity boundary.
δ—a global sensitivity parameter (e.g., as translated from a value set by the user)
δ—an internal sensitivity parameter set independently for each attribute
μ—the mean associated with the cluster associated with τ
α—a slope parameter configured to define a shape of the buffer for small means
β—an intercept parameter configured to define a value of the buffer for a zero mean.
   It is noted that as indicated in FIG. 6, and as provided above, the sensitivity function 49 applies to both maximum (+) and minimum (−) learned behavior boundaries 88.

Taken together, the second and third terms of the above-relation relate to a sensitivity adjustment value which the host device 25 can apply to a learned behavior boundary 88. Details of the generation of the sensitivity adjustment value are provided below.

The second term in the relation,

$$γ μ \frac{μ}{τ} ,$$

adds a portion of the mean μ of a cluster to the computed learned behavior boundary 88, also referenced as the variance, τ, based upon the ratio of the mean μ relative to the variance τ of the underlying data. As such, both the variance of a cluster 82, as defined by the learned behavior boundary 88, and the mean of that cluster 82 can affect the sensitivity boundary value.

For example, assume the case where each of the cluster elements 82 relate to the attribute of CPU utilization and have a relatively large mean value and a relatively small variance value. Such values result in the term

$$γ μ \frac{μ}{τ}$$

having a relatively large value which, in turn, results in the sensitivity boundary or adjusted buffer value, τ*, as having a relatively large value. Accordingly, the host device 25 generates a relatively large adjusted buffer value τ* in order to decrease the sensitivity of anomaly detection. In another example, assume the case where each of the cluster elements 82 relate to the attribute of latency and have a relatively small mean value and a relatively small variance value. Such values result in the term

$$γ μ \frac{μ}{τ}$$

having a relatively small value which, in turn, results in the sensitivity boundary or adjusted buffer value, τ*, as having a relatively small value. Accordingly, the host device 25 generates a relatively small adjusted buffer value τ*. Therefore, depending upon the attribute associated with the data elements 28, sensitivity function 49 is configured to take different variances into account when generating the sensitivity boundaries 92.

As part of the second term, the sensitivity parameter γ is configured as an internal sensitivity parameter set independently for each attribute that can scale the second term in the relation based upon the attribute/object combination. In one arrangement, the default value for the sensitivity parameter γ is 1. In order to increase or decrease the detection sensitivity for any attribute/object, the value of the γ parameter can be increased or decreased, respectively. In one arrangement, the γ parameter value can be set based upon expert knowledge, but may be adjusted pursuant to experimentation.

It is noted that as a multiplier, small changes in γ may have a relatively large impact on the second term of the relation and/or on the resulting adjusted buffer value. In one arrangement, to minimize the impact of this parameter, the γ parameter can be limited to a particular range of values, such as a range of γ ∈ [0.5,1.0], so that one attribute can be detected with a limited sensitivity (e.g., at most twice) relative to another attribute. In one arrangement, the sensitivity for attributes that are more important to detect can be increased (i.e., where “weaker” anomalies may be more indicative of a serious problem).

The third term in the relation, β^{(1-μ/α)}, is configured to add a relatively small-mean buffer value to the adjusted buffer value in order to reduce the number of relatively insignificant anomalies presented to the end user. For example, in the case where the mean value μ is relatively small, the third term in the relation can remain substantially equal to the value of the intercept parameter β. In another example, in the case where the mean value μ is relatively large, such as for CPU Ready times which may consistently be on the order of 100, the third term in the relation has virtually no impact on the adjusted buffer value, τ*.

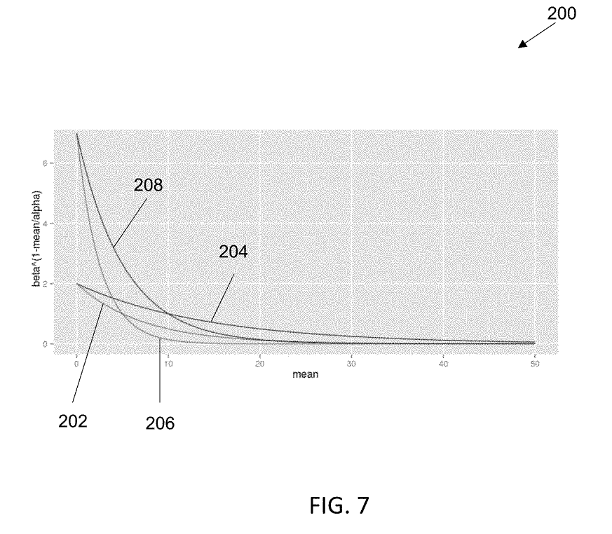

FIG. 7 is a graph 200 that illustrates, in part, how the mean value of a cluster 82 influences the third term of the relation. Four scenarios are depicted by the graph: a first curve 202 with the intercept parameter β=2 and the slope parameter α=5, a second curve 204 with the intercept parameter β=2 and the slope parameter α=10, a third curve 206 with the intercept parameter β=7 and the slope parameter α=5, and a fourth curve 208 with the intercept parameter β=7 and the slope parameter α=10. As shown for each curve 202, 204, 206, 208, with relatively small mean values μ of a cluster 82, the intercept parameter β can remain relatively unchanged. As the mean value μ of a cluster 82 becomes relatively large, the value of the third term in the relation is reduced to zero. Consequently, default parameter values, γ, α, β, are generally adequate for any attribute which is expected to consistently take on large values.

As provided above, the parameter β is an intercept parameter that defines the value of the sensitivity buffer for a zero mean. The third term in the relation is configured as a decreasing exponential function that crosses the y-axis at β. For example, with continued reference to the graph 200 of FIG. 7, the first and second curves 202, 204 identify β=2 while the third and fourth curves identify β=7. As indicated, the third term in the relation decreases from β to 0 as the mean value for a cluster 82 becomes large.

In one arrangement, the parameter β can be specified per-attribute, based upon a desired decision buffer when the mean value is equal to zero. Accordingly, the value of the parameter β can depend upon the minimum value that is considered meaningful for the attribute/object under consideration. In one arrangement, the value of the parameter β is set such that β>1, since it is over this interval that the exponential function decreasing. For example, when an intercept is desired at 1 or lower, the value of the parameter β can be set to β=2 and can scale the second term in the relation by an appropriate amount (e.g., v/2, where v is the desired intercept).

As provided above, with respect to the third term of the relation, the parameter α is a slope parameter that defines the shape of the buffer or sensitivity buffer value for relatively small mean values. The parameter α is an exponential term, as indicated in the third term in the relation, having a value α>0 that decreases from β to 0 and that passes through 1 when the mean value equals α. For example, in FIG. 7, α=5 and α=10. The parameter α defines how quickly the exponential function degrades to 0, i.e., at what mean value the second term loses significant influence over the sensitivity buffer value as a whole. For each metric/object, this may depend upon the associated average meaningful values.

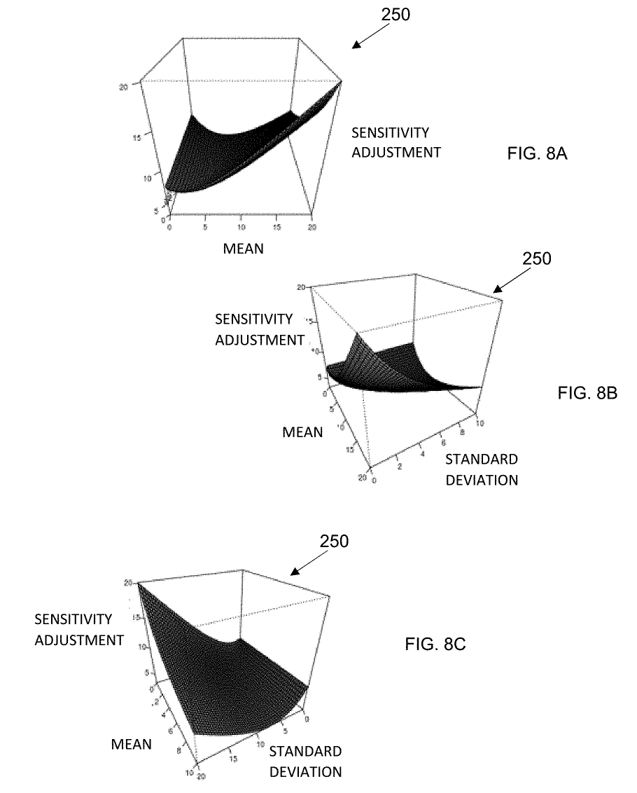

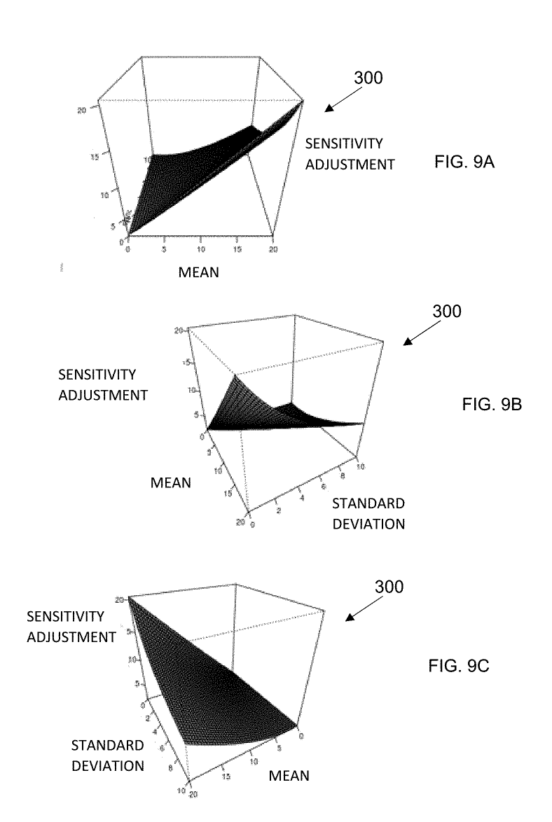

As provided above, the sensitivity function 49 is configured to relate the mean value of a given cluster 82 with a learned behavior boundary value. FIGS. 8 and 9 illustrate the relationships among the adjusted buffer value (i.e., the sensitivity adjustment), the mean value of a cluster (for mean values between 0 and 20), and the standard deviation (for standard deviation values between 0 and 10). FIGS. 8 and 9 also illustrate how the alpha and beta values influence the adjustment of the sensitivity boundary, by the sensitivity adjustment value. For example, with reference to a graph 250 illustrated in FIGS. 8A through 8C, β=7.4 and α=10. In another example, with reference to graph 300 illustrated in FIGS. 9A through 9C, β=2 and α=10.

As is indicated in the graphs 250, 300 of FIGS. 8 and 9, respectively, the sensitivity adjustment value (i.e., second and third terms of the above-relation) changes based upon the mean and the standard deviation of a given cluster 82. As indicated in both FIGS. 8 and 9, the sensitivity adjustment value is at its peak when standard deviation value is relatively low and the mean value is relatively high. With reference to FIG. 9, if the mean value is at or near zero and the standard deviation is at or near zero, then the sensitivity adjustment value is also relatively low.

By executing the sensitivity function 49, the host device 25 can be configured to apply the resulting sensitivity adjustment value or adjusted buffer value as first and second sensitivity boundaries 92-1, 92-2 to the learned behavior boundaries 88, as illustrated in FIG. 6. Accordingly, the host device 25 can refrain from reporting relatively insignificant anomalies to the end user. This allows the host device 25 to improve the practical meaning of anomalies derived from machine learning models and to limit or avoid reporting of insignificant anomalies. For example, as a result of the application of the sensitivity function 49 to the clusters 82, the resulting sensitivity boundaries 92-1, 92-2, minimizes or eliminates data element 84-3 as being considered an anomalous data element.

In one arrangement, the host device 25 is configured to incorporate user input into the anomaly detection process. For example, as indicated in the relation above, the sensitivity function 49 is configured with a global sensitivity parameter δ which is translated from a value set by the user. Accordingly, the end user can select the global sensitivity parameter δ to effectively influence the semantics of the sensitivity adjustment provided by the sensitivity function 49.

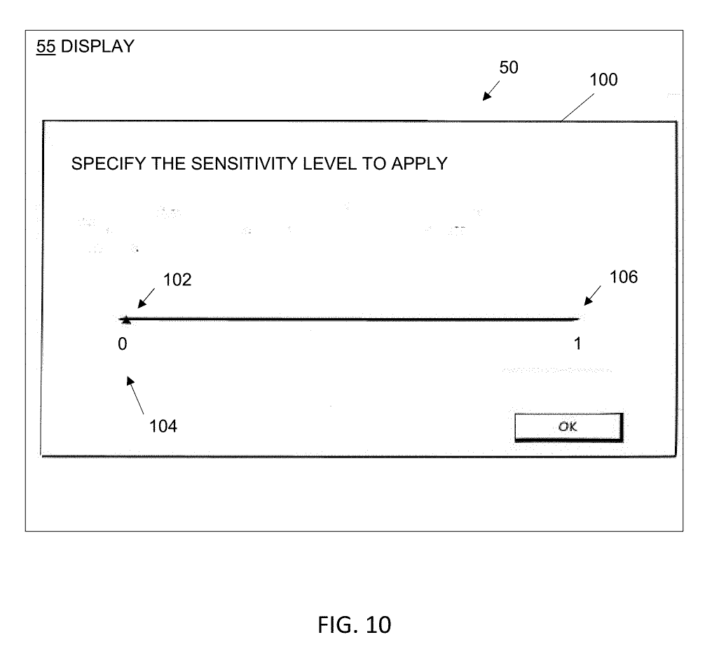

In one arrangement, the host device 25 is configured to provide the end-user with a mechanism for inputting the global sensitivity parameter to the sensitivity function 49. For example, with reference to FIG. 10, the host device 25 is configured to provide a graphical user interface 50 to the display 55 to allow the user to adjust the global sensitivity parameter δ of the sensitivity function 49. As shown, the graphical user interface 50 provides a sensitivity selection screen 100 that includes a slider control 102 that can slide between values 0-1 with a 0.01 step size. At the same time graphical user interface 50 can also interpret those values in any other different way such as: low/medium/high (i.e. specific to the UI/Ux).

In use, the system administrator can use a mouse or a touch-enabled interface device such as a tablet, to select the slider control 102 and slide between the first value 104 and the second value 106. Based upon the selected value, the host device 25 can map the value to a particular global sensitivity parameter δ 110 to be utilized as part of the sensitivity function 49. Based upon the selection, the host device 25 is configured adjust the sensitivity adjustment value of the sensitivity boundary based upon the global sensitivity parameter 110.

As described above, the sensitivity function 49 is configured to generate a sensitivity boundary 92 related to a variance associated with a cluster 82 and to a mean value of the cluster 82, as associated with a particular type of data element 28. Such description is by way of example only. The sensitivity boundary or adjusted buffer value, τ*, can be generated in a variety of ways. For example, the sensitivity function 49 can be provided by any of the following relations.

In one arrangement, the sensitivity function 49 is provided by the relation

$${τ}_{i}^{*} = {τ}_{i} ( 1 + \frac{γ δ}{{c}_{vi} + 1} ) ,$$

where τᵢ is the original buffer, δ is a global sensitivity parameter (e.g., translated from a value set by the user), γ is an internal sensitivity parameter set independently for each metric, and cᵥᵢ is the coefficient of variation for cluster i defined by cᵥᵢ=sᵢ/xᵢ, where sᵢ and xᵢ are the sample standard deviation and sample mean (from the relevant cluster), respectively.

In one arrangement, the sensitivity function 49 is provided by the relation

$${τ}_{i}^{*} = {τ}_{i} ( 1 + γ δ - \frac{{c}_{vi} γ δ}{\sqrt{{n}_{i}}} ) ,$$

where nᵢ is the cluster size, and all other values are as defined above. In one arrangement, the sensitivity function 49 is provided by the relation τ*ᵢ=τᵢ(1+δ), where δ is as defined above. In one arrangement, the sensitivity function 49 is provided by the relation

$${τ}_{i}^{*} = {τ}_{i} + \sqrt{{μ}_{i}} ( \frac{γ δ}{{c}_{vi} + 1} ) .$$

In one arrangement, the sensitivity function 49 is provided by the relation

$${τ}_{i}^{*} = {τ}_{i} + {μ}_{i} ( \frac{γ δ}{{c}_{vi} + 1} ) .$$

In one arrangement, the sensitivity function 49 is provided by the relation

$${τ}_{i}^{*} = {τ}_{i} + γ δ {μ}_{i} \frac{1}{{c}_{vi} + 1} + δ {e}^{- α μ + β} .$$

In one arrangement, the sensitivity function 49 is provided by the relation

$${τ}_{i}^{*} = {τ}_{i} + γ δ {μ}_{i} \frac{μ}{τ} + δ {e}^{- α μ + b} .$$

In one arrangement, the sensitivity function 49 is provided by the relation

$${τ}_{i}^{*} = {τ}_{i} + γ δ {μ}_{i} \frac{μ}{τ} + δ {e}^{ln ( β ) ( 1 - μ / α )} .$$

While various embodiments of the innovation have been particularly shown and described, it will be understood by those skilled in the art that various changes in form and details may be made therein without departing from the spirit and scope of the innovation as defined by the appended claims.

1. In a host device, a method for performing an anomaly analysis of a computer environment, comprising:
applying, by host device, a learned behavior function to a data training set and to a set of data elements received from at least one computer environment resource to define at least one learned behavior boundary relative to at least one cluster of data elements of the data training set, the at least one learned behavior boundary related to a variance associated with the at least one cluster;
applying, by host device, a sensitivity function to the at least one cluster to define a sensitivity boundary relative to at least one learned behavior boundary, the sensitivity boundary related to the variance associated with the at least one cluster and to a mean value of the at least one cluster; and
identifying, by host device, a data element of the set of data elements as an anomalous data element associated with an attribute of the at least one computer environment resource when the data element of the set of data falls outside of the sensitivity boundary.

2. The method of claim 1, wherein the learned behavior function defines the learned behavior boundary as being three standard deviations from a centroid of the at least one cluster.

3. The method of claim 1, wherein the sensitivity boundary further relates to a ratio of the mean value of the at least one cluster and the variance of the at least one cluster.

4. The method of claim 1, wherein applying the sensitivity function to the at least one cluster further comprises adjusting, by the host device, a value of the sensitivity boundary for a relatively small mean value of the at least one cluster.

5. The method of claim 1, further comprising:
receiving, by the host device, a user-selected global sensitivity parameter; and
adjusting, by the host device, a sensitivity adjustment value of the sensitivity boundary based upon the global sensitivity parameter.

6. The method of claim 5, wherein receiving the global sensitivity parameter based upon the user selected input value comprises:
displaying, by the host device and via a graphical user interface, a sensitivity selection screen; and
receiving, by host device, the global sensitivity parameter based upon a user-selected input value provided from the sensitivity selection screen.

7. The method of claim 1, further comprising:
receiving, by the host device, the set of data elements from the at least one computer environment resource of the computer infrastructure, each data element of the set of data elements relating to an attribute of the at least one computer environment resource; and
applying, by host device, a clustering function to the set of data elements to define the data training set.

8. The method of claim 1, wherein the sensitivity function satisfies the following relation:
$${τ}_{i}^{*} = τ \pm δ ( γ μ \frac{μ}{τ} + {β}^{( 1 - μ / α )} )$$
wherein τ* relates to a sensitivity boundary value, τ relates to the variance of the at least one cluster 82, δ relates to a user-selected global sensitivity parameter, γ related to an internal sensitivity parameter, μ relates to the mean value of the at least one cluster, α relates to a slope parameter configured to define a shape of the sensitivity boundary for a relatively small mean value, and β relates to an intercept parameter configured to define a value of the sensitivity boundary for a zero mean value.

9. A host device, comprising:
a controller comprising a memory and a processor, the controller configured to:
apply a learned behavior function to a data training set and to a set of data elements received from at least one computer environment resource to define at least one learned behavior boundary relative to at least one cluster of data elements of the data training set, the at least one learned behavior boundary related to a variance associated with the at least one cluster;
apply a sensitivity function to the at least one cluster to define a sensitivity boundary relative to at least one learned behavior boundary, the sensitivity boundary related to the variance associated with the at least one cluster and to a mean value of the at least one cluster; and
identify a data element of the set of data elements as an anomalous data element associated with an attribute of the at least one computer environment resource when the data element of the set of data falls outside of the sensitivity boundary.

10. The host device of claim 9, wherein the learned behavior function defines the learned behavior boundary as being three standard deviations from a centroid of the at least one cluster.

11. The host device of claim 9, wherein the sensitivity boundary further relates to a ratio of the mean value of the at least one cluster and the variance of the at least one cluster.

12. The host device of claim 9, wherein when applying the sensitivity function to the at least one cluster, the host device is further configured to adjust a value of the sensitivity boundary for a relatively small mean value of the at least one cluster.

13. The host device of claim 9, wherein the host device if further configured to:
receive a user-selected global sensitivity parameter; and
adjust a sensitivity adjustment value of the sensitivity boundary based upon the global sensitivity parameter.

14. The host device of claim 13, wherein when receiving the global sensitivity parameter based upon the user selected input value, the host device is configured to:
display, via a graphical user interface, a sensitivity selection screen; and
receive the global sensitivity parameter based upon a user-selected input value provided from the sensitivity selection screen.

15. The host device of claim 9, wherein the host device is further configured to:
receive the set of data elements from the at least one computer environment resource of the computer infrastructure, each data element of the set of data elements relating to an attribute of the at least one computer environment resource; and
apply a clustering function to the set of data elements to define the data training set.

16. The host device of claim 9, wherein the sensitivity function satisfies the following relation:
$${τ}_{i}^{*} = τ \pm δ ( γ μ \frac{μ}{τ} + {β}^{( 1 - μ / α )} )$$
wherein τ* relates to a sensitivity boundary value, τ relates to the variance of the at least one cluster 82, δ relates to a user-selected global sensitivity parameter, δ related to an internal sensitivity parameter, μ relates to the mean value of the at least one cluster, α relates to a slope parameter configured to define a shape of the sensitivity boundary for a relatively small mean value, and β relates to an intercept parameter configured to define a value of the sensitivity boundary for a zero mean value.

17. A computer program product encoded with instructions that, when executed by a controller of a host device, causes the controller to:
apply a learned behavior function to a data training set and to a set of data elements received from at least one computer environment resource to define at least one learned behavior boundary relative to at least one cluster of data elements of the data training set, the at least one learned behavior boundary related to a variance associated with the at least one cluster;
apply a sensitivity function to the at least one cluster to define a sensitivity boundary relative to at least one learned behavior boundary, the sensitivity boundary related to the variance associated with the at least one cluster and to a mean value of the at least one cluster; and
identify a data element of the set of data elements as an anomalous data element associated with an attribute of the at least one computer environment resource when the data element of the set of data falls outside of the sensitivity boundary.
